(19) United States
(12) Patent Application Publication
(10) Pub. No.: US 2013/0041613 A1
(43) Pub. Date: Feb. 14, 2013

(54) GENERATING A TEST SUITE FOR BROAD COVERAGE

(71) Applicants: Manish Anand Bhide, New Delhi (IN); Nithinkrishna Shenoy, Mangalore (IN)

(72) Inventors: Manish Anand Bhide, New Delhi (IN); Nithinkrishna Shenoy, Mangalore (IN)

(73) Assignee: INTERNATIONAL BUSINESS MACHINES CORPORATION, Armonk, NY (US)

(21) Appl. No.: 13/207,185

(22) Filed: Aug. 10, 2011

(51) Int. Cl. G06F 19/00

(52) U.S. Cl. 702/123

(57) ABSTRACT

For generating a test suite, a selection module receives a maximum time for executing a plurality of test cases, each test case comprising metadata and a plurality of components, each component comprising test instructions and an intensity. The selection module further selects a first test case of the plurality of test cases with a specified priority selected iteratively from a highest priority to a lowest priority as a selected test case if combined expected time durations for all selected test cases and a minimum expected time duration of the first test case is less than the maximum time. A generation module selects a specified intensity for the first test case and generates the test suite from the selected test cases and the specified intensity for each selected test case.

### BACKGROUND

1. Field

The subject matter disclosed herein relates to test suites and more particularly relates to test suite generation.

2. Description of the Related Art

Many products such as software, electrical devices, and semiconductors are tested extensively using test suites. A test suite may include a number of automated tests to evaluate the product's compliance with design parameters. Test suites will often be executed regularly during the development of the product to evaluate changes to the design and/or implementation. Varying time intervals may be available to execute a test suite.

### BRIEF SUMMARY

A method for generating a test suite is presented. A computer readable storage medium stores computer readable program code executable by a processor. A selection module receives a maximum time for executing a plurality of test cases, each test case comprising metadata specifying a priority, an expected time duration for each of a plurality of intensities, a past failures history, and required test resources, each test case further comprising a plurality of components, each component comprising test instructions and an intensity. The selection module further selects a first test case of the plurality of test cases with a specified priority selected iteratively from a highest priority to a lowest priority as a selected test case if combined expected time durations for all selected test cases and a minimum expected time duration of the first test case is less than the maximum time,

A generation module selects a specified intensity for the first test case such that the combined expected time durations for all selected test cases is less than the maximum time. The generation module further generates the test suite from the selected test cases and the specified intensity for each selected test case. An apparatus and computer program product also perform the functions of the method.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a test suite;

FIG. 2 is a schematic block diagram illustrating one embodiment of metadata;

FIG. 3 is a drawing illustrating one embodiment of a test script;

FIG. 4 is a drawing illustrating one embodiment of a metadata table;

FIG. 5 is a schematic block diagram illustrating one embodiment of generation apparatus;

FIGS. 6A-B are schematic flow chart diagrams illustrating one embodiment of a test suite generation method; and

FIGS. 7A-C are schematic block diagrams illustrating one embodiment of test suites.

### DETAILED DESCRIPTION OF THE INVENTION

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

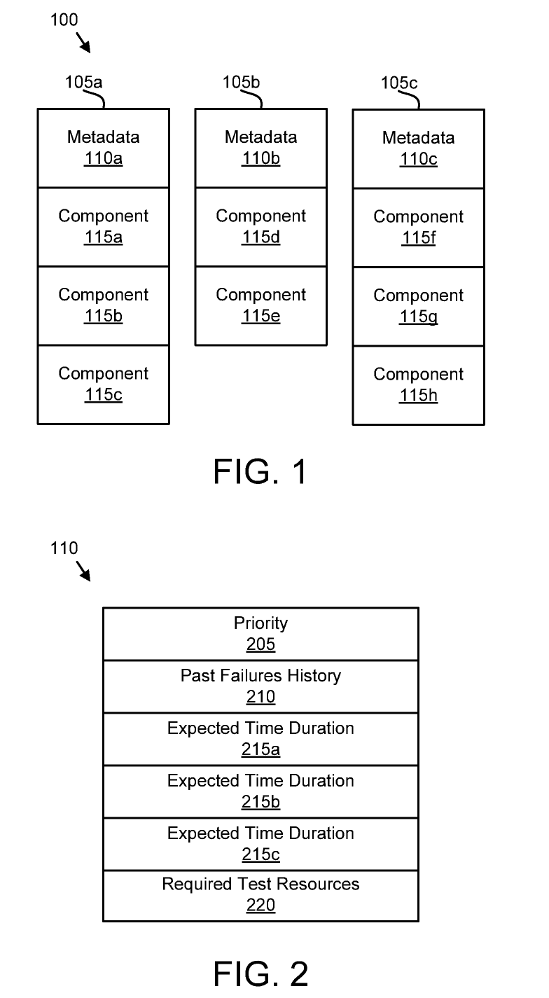

FIG. 1 is a schematic block diagram illustrating one embodiment of a test suite 100. The test suite 100 includes a plurality of test cases 105. Each test case 105 may include one or more test scripts. In one embodiment, each test case 105 includes metadata 110 and one or more components 115.

The test suite 100 may be used to test a product such as a semiconductor, a software program, an electronic device, a system comprising electrical, software, and mechanical components, a communications system, or the like. In one embodiment, the test cases 105 are executed in the sequential order from the first test case 105a to a last test case 105c. When a test case 105 is executed, the metadata 110 may direct the configuration for the test case 105. The components 115 may test the product and/or features of the product to determine if the product is in compliance with design parameters.

FIG. 2 is a schematic block diagram illustrating one embodiment of metadata 110. The metadata 110 may be the metadata 110 of FIG. 1. The description of the metadata 110 refers to elements of FIG. 1, like numbers referring to like elements. The metadata 110 may include a priority 205, of past failures history 210, one or more expected time durations 215, and required test resources 220.

The priority 205 may indicate an importance of the test case 105 relative to other test cases 105. The priority 205 may be a scalar number such as the numbers one to 10. In a certain embodiment, the number one indicates the highest priority while a number 10 indicates the lowest priority. Alternatively the number 10 may indicate the highest priority. One of skill in the art will recognize that embodiments may be practiced with scales for the priority 205.

In one embodiment, test cases 105 with higher priorities 205 are executed before test cases 105 with lower priorities. In addition, one or more test cases 105 may share a priority value. For example, a first test case 105a and second test case 105b may share the priority 1. In an alternate embodiment, each test case 105 has a unique priority 205.

The past failures history 210 may record quantities, qualities and characteristics of past failures that occurred while executing the test case 105. In one embodiment, the past failures history 210 is a number of failures occurring during a single execution of the test case 105. Alternatively, the past failures history 210 may include a log entry for each failure. The log entries may include a timestamp, a test suite name, a test case name, a component name, a test setup, one or more input data values, one or more initial states, a preceding state, a subsequent state, and the like. The past failures history 210 may comprise quantities, qualities and characteristics of past failures for a single execution of the test case 105. Alternatively, the past failures history 210 may include the quantities, qualities and characteristics of multiple executions of the test case 105.

In one embodiment, the expected time duration 215 is an estimate of the time interval required to execute the test case 105. In an alternate embodiment, a plurality of expected time durations 215 estimate the time interval required to execute each component 115 of the test case 105.

In a certain embodiment, the expected time duration 215 is estimated for a specified intensity of the test case 105. Thus a plurality of expected time durations 215 may be estimated for the test case 105. For example, the first test case 105a may have an expected time duration 215 of five minutes for an intensity of 1 and ten minutes for an intensity of 2.

The expected time duration 215 may be a last recorded time interval required to execute the test case 105 and/or the component 115 of the test case 105. Alternatively, the expected time duration 215 may be based on an analysis of instructions in the test case 105 and/or component 115.

The required test resources 220 may specify test equipment, test equipment configurations, test equipment parameters, products, product configurations, product parameters, software images, software configurations, software parameters, and the like. In one embodiment, the required test resources 220 specifies unique configurations for each component 115 of the test case 105. Alternatively, the required test resources 220 specify a single configuration and parameters for all components 115 of the test case 105 along with products and software used with the test case 105.

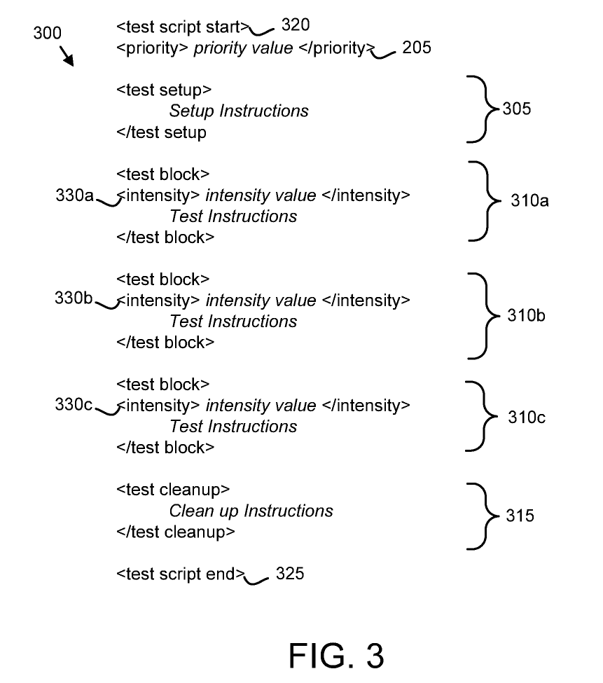

FIG. 3 is a drawing illustrating one embodiment of a test script 300. The test script 300 may embody a test case 105. The test case 105 may be executed by executing the test script 300. The description of the test script 300 refers to elements of FIGS. 1-2, like numbers referring to like elements. The test script 300 is shown rendered in an exemplary test script language. The test script 300 includes a test script start 320, a priority value 205, a test setup 305, a test cleanup 315, a test script end 325, and one or more test blocks 310.

The test script start 320 may indicate the beginning of the test case 105. Similarly, the test script end 325 may indicate the end of the test case 105. In one embodiment, the test setup 305 includes the required test resources 220 of FIG. 2. In addition, each test block 310 may be a component 115. Alternatively, a component 115 may comprise one or more test blocks 310.

Each component 115 includes an intensity 330. The intensity may be a scalar number. In one embodiment, the value of the intensity increases for more thorough testing. Alternatively, the value of the intensity may decrease for more thorough testing. The intensity 334 of a component 115 may be the intensity 330 of the first test block 310a of the component. In a certain embodiment, each test block 310 of each component 115 includes an intensity 330. In one embodiment, the intensity determines whether the component 115 and/or test block 310 of the test case 105 is executed. For example, if the specified intensity is 2, all components 115 and/or test blocks 310 with an intensity of two or higher may be executed.

The test case 105 may be executed by reading the test script start 320 and executing the setup instructions of the test setup 305. The setup instructions may check for required test equipment, products, and software either automatically, or by prompting a test administrator. The setup instructions may further configure and set the parameters for the test equipment, products, and software. In addition, the setup instructions may initialize one or more data structures to receive test results. The test blocks 310 may be executed sequentially. In one embodiment, only test blocks 310 with an intensity 330 that exceeds an intensity threshold are executed.

The cleanup instructions of the test cleanup 315 may store the results from executing each test block 310, restore test configurations and test parameters to initial state, and the like. The test script end 325 may indicate that the test case 105 is completed.

One of skill in the art will recognize that embodiments may be practiced with one of a plurality of standard scripting languages, a custom scripting language, and the like. In one embodiment, the test script 300 is parsed and executed. Alternatively, the test script 300 may be compiled into an executable format, and the executable format executed.

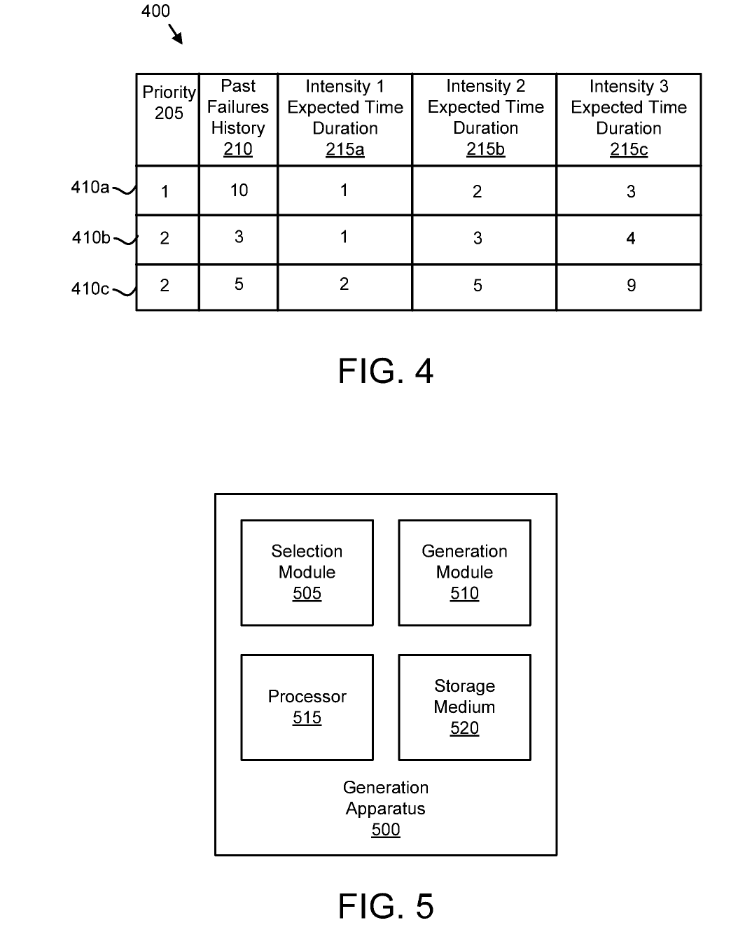

FIG. 4 is a drawing illustrating one embodiment of a metadata table 400. The metadata table 400 may be created from the metadata 110 FIGS. 1-2. The description of the metadata table 400 refers to elements of FIGS. 1-3, like numbers referring to like elements.

In one embodiment, the metadata 110 of one or more test cases 105 is parsed to create the metadata table 400. For example, the depicted metadata table 400 may include an entry 410 for the metadata 110 of each test case 105 of FIG. 1. In addition, one or more alternative data sources may be parsed to create the metadata table 400. For example, test logs, test databases, test scripts 300, and the like may be parsed for the past failures history 210 and the expected time duration 215.

In one embodiment, the expected time duration 215 estimates the execution time of the test case 105 for each specified intensity. For example, the test case 105 may have an intensity 1 expected time duration 215a for an intensity of 1, an intensity 2 expected time duration 215b for an intensity of 2, and an intensity three expected time duration 215c for intensity of 3.

FIG. 5 is a schematic block diagram illustrating one embodiment of generation apparatus 500. The apparatus 500 may be embodied in a computer, a server, a dedicated test client, and the like. The description of the apparatus 500 refers to elements of FIGS. 1-4, like numbers referring to like elements. The apparatus 500 includes a selection module 505, a generation module 510, a processor 515, and a storage medium 520.

The storage medium 520 may be a computer readable storage medium. The storage medium 520 may store computer readable program code. The processor 515 may execute the computer readable program code. In one embodiment, the selection module 505 and a generation module 510 are embodied in the computer readable program code.

The selection module 505 receives a maximum time for executing a plurality of test cases 105. The selection module 505 further selects a first test case 105a of the plurality of test cases 105 with a specified priority 205 selected iteratively from a highest priority to a lowest priority as a selected test case if combined expected time durations 215 for all previously selected test cases and a minimum expected time duration of the first test case 105a is less than the maximum time.

The generation module 510 selects a specified intensity for the first test case 105a such that the combined expected time durations for all selected test cases 105 is less than the maximum time. The generation module further generates the test suite 100 from the selected test cases 105 and the specified intensity for each selected test case.

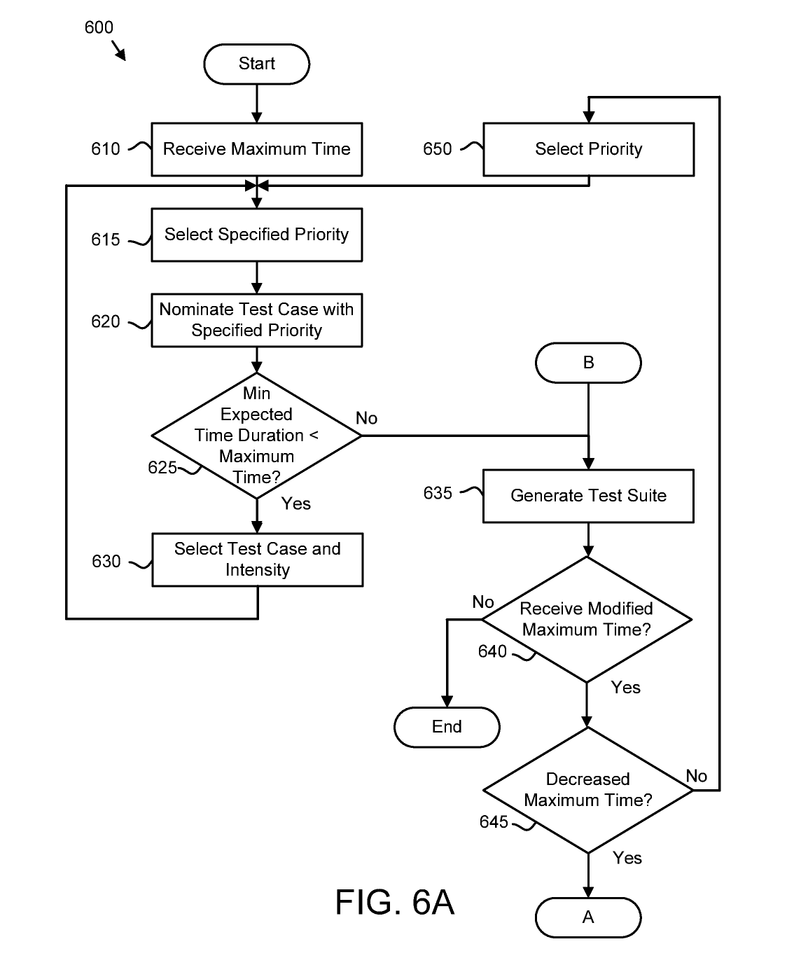

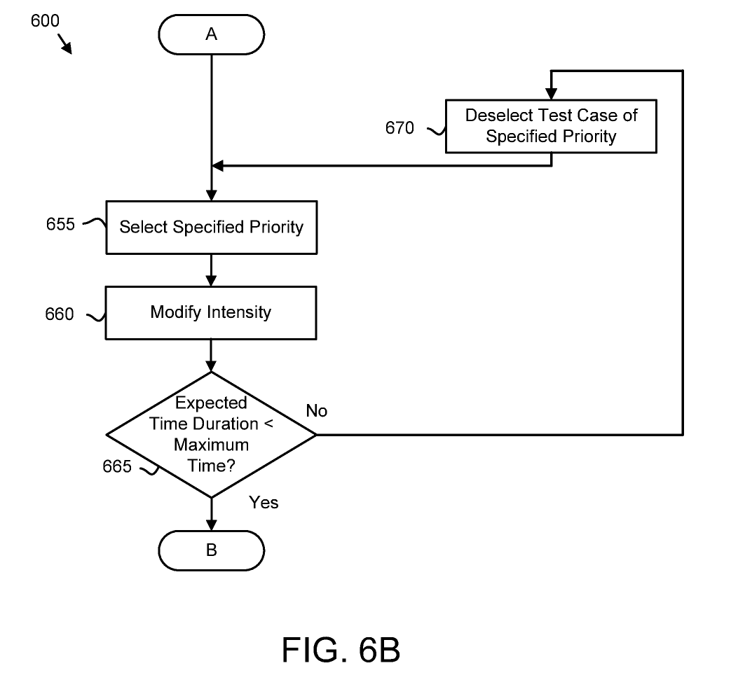

FIGS. 6A-B are schematic flow chart diagrams illustrating one embodiment of a test suite generation method 600. The method 600 performs the functions of the apparatus 500 of FIG. 5. The description of the method 600 refers to elements of FIGS. 1-5, like numbers referring to like elements.

The method 600 starts, and in one embodiment, the selection module 505 receives 610 a maximum time for executing the plurality of test cases 105. The maximum time may be received 610 from the test administrator. Alternatively, the maximum time may be derived from an automated schedule. In one embodiment, the maximum time is calculated from the stop time and a current time.

The selection module selects 615 a specified priority. The specified priority may be iteratively selected from a highest priority 205 to a lowest priority 205. For example, the selection module 615 may initially select a highest priority 205 of 1, followed by a next priority 205 of 2, and so on until the lowest priority 205 is selected.

The selection module 505 further nominates 620 a first test case 105a of the plurality of test cases 105 with the specified priority. The selection module 505 may iteratively nominate 620 test cases 105 with the highest priority that have not yet been nominated until all such test cases 105 have been nominated. The selection module 615 then nominates 615 test cases with the next highest priority.

For example, the selection module 505 may begin with a specified priority 205 equal to the highest priority 205 of 1. The selection module may identify each test case 105 with a priority 205 of 1. If more than one test case 105 comprises the specified priority, the first test case 105a is nominated and selected from other test cases 105 with the specified priority in response to the first test case 105a having a worst past failures history. Alternatively, the first test case 105a may be nominated and selected from other test cases 105 with the specified priority in response to the first test case 105a having a shortest minimum expected time duration 215.

The selection module 505 determines 625 if a combined expected time durations 215 for all previously selected test cases 105 and a minimum expected time duration of the first test case 105a is less than the maximum time. In one embodiment, the combined expected time durations 215 are calculated as a sum of each expected time duration 215 for each selected test case 105 at a selected intensity 330. The combined expected time durations 215 Tc may be calculated using Equation 1, where Te is the expected time duration 215 of a test case for a selected intensity 330.

Tc=ΣTe

The minimum expected time duration for the first test case 105a may be the shortest expected time duration of the plurality of time durations 215 for the first test case 105a. For example, if the first test case 105a includes the first metadata 110a of FIG. 4, then the intensity 1 expected time duration 215a of the metadata table 400 with a value of 1 is the minimum expected time duration.

If the combined expected time durations 215 for all selected test cases and the minimum expected time duration of the first test case 105a is less than the maximum time, the generation module 510 selects 630 the first test case 105a and a specified intensity for the first test case 105a such that the combined expected time durations 215 for all selected test cases 105 including the first test case 105a is less than the maximum time. The selected intensity may be a highest intensity 330 where the combined expected time durations 215 for all selected test cases 105 including the first test case 105a is less than the maximum time.

For example, if the maximum time is 60 minutes, the combined expected time durations 215 for all previously selected tests at specified intensities is 50 minutes, and the expected time durations 215 for the first test case 105a are 5 minutes for a first intensity, 9 minutes for a second intensity, and 13 minutes for a third intensity, the selection module 505 may select 630 the second intensity as the highest intensity where the combined expected time durations 215 for all selected test cases 105 including the first test case 105a of 59 minutes is less than the maximum time of 60 minutes.

In one embodiment, where a plurality of test case 105 have a same priority 205, a higher intensity 330 is selected for the first test case 105a relative to other test cases 105 with the specified priority in response to the first test case 105a having a worst past failures history 210. Alternatively, a higher intensity 330 is selected for the first test case 105a relative to other test cases 105 with the specified priority in response to the first test case 105a having a shortest minimum expected time duration for the higher intensity.

If the combined expected time durations 215 for all selected test cases 105 and the minimum expected time duration of the first test case 105a is less than the maximum time, the generation module 510 generates 635 the test suite 100 from the selected test cases 105 and the specified intensity for each selected test case 105. In one embodiment, the generation module 510 generates 635 the test suite 100 with the selected test cases 105 arranged in a descending priority order from highest priority 205 to lowest priority 205.

In one embodiment, the selection module 505 determines 640 if a modified maximum time is received. If a modified maximum time is not received, the method 600 ends. If the modified maximum time is received, selection module 505 determines 645 if the maximum time is decreased.

If the maximum time is not decreased, the selection module 505 selects 650 a priority 205 beginning with the highest priority 205, selects 615 a specified priority, and nominates 620 a first test case 105a of the plurality of test cases 105 with the specified priority. In one embodiment, only the priorities 205 of unexecuted test cases are selected. Each test case 105 may be re-nominated 620 and the specified intensity for the test cases 105 modified such that the combined expected time durations for all selected test cases 105 is less than the maximum time. In one embodiment, a second test case 105b that was previously not selected may be selected as a selected test case 105 if after the specified intensity of the selected test cases 105 is modified the combined expected time durations for all selected test cases is less than the maximum time.

If the maximum time is decreased, the selection module 505 may iteratively select 655 the specified priority from the lowest priority 205 to the highest priority 205. In addition, the selection module 505 may iteratively modify 660 the specified intensity for each selected test case 105 with the specified priority such that the combined expected time durations for all selected test cases is less than the maximum time.

The selection module 505 may determine 665 if the combined expected time durations 215 of the selected test cases 105 is less than the maximum time. If the selection module 505 determines 665 that the combined expected time durations 215 is not less than the maximum time, the selection module 505 may deselect a second test case 105b with the specified priority and select 655 the specified priority. If the selection module 505 determines 665 that the combined expected time durations 215 are less than the maximum time, the generation module 510 generates 635 the test suite 100 from the selected test cases 105 and the specified intensity for each selected test case 105.

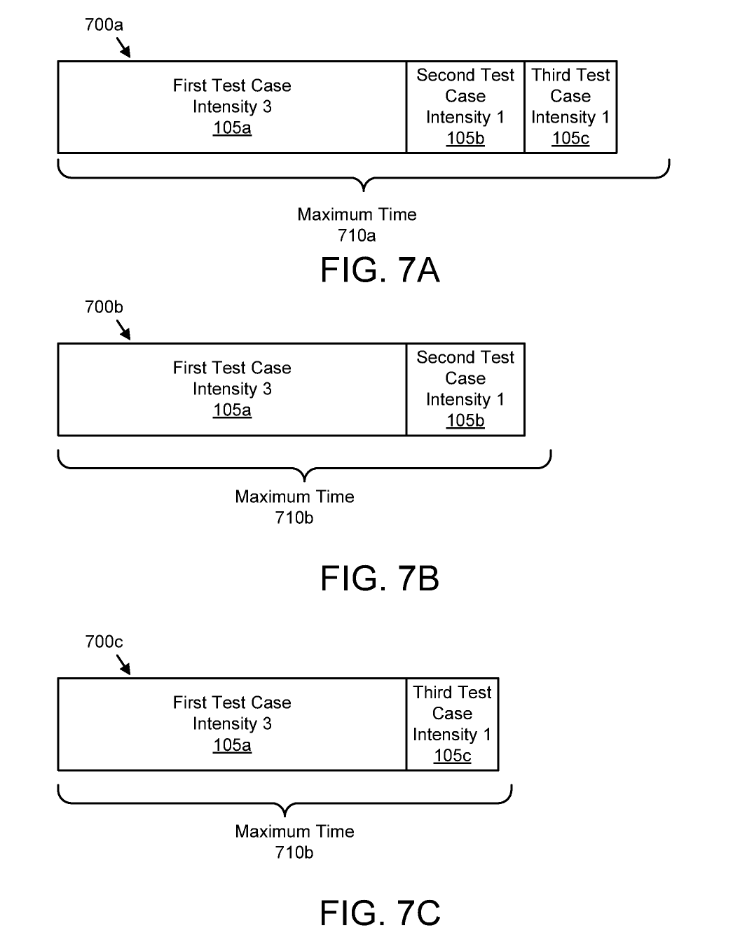

FIGS. 7A-C are schematic block diagrams illustrating one embodiment of generated test suites 700. The generated test suites 700 illustrate examples of generating test suites 700 for various maximum times 710 using the method 600 and apparatus 500. The descriptions of the generated test suites 700 refer to elements of FIGS. 1-6, like numbers referring to like elements.

FIG. 7A shows a first maximum time 710a. A first test case 105a is selected. Because the first test case 105a can be executed with an intensity 330 of 3 within the maximum time 710a, the intensity 330 of 3 is also selected. A second test case 105b is also selected. However, because the second test case 105b can only be executed with an intensity 330 of 1 within the maximum time 710a, the intensity 330 of 1 is selected for the second test case 105b. A third test case 105c is also selected. The third test case 105c can also only be executed with an intensity 330 of 1 within the maximum time 710a, so intensity of one is selected for the third test case 105c.

In one embodiment, each test case 105 with a same priority 205 is selected with a lowest intensity 330 until all test cases 105 with the same priority 205 are selected. The intensities 330 of the test cases 105 with the same priority 205 may be iteratively increased while the combined expected time durations 215 are less than the maximum time.

FIG. 7B illustrates a second maximum time 710b. Because a second maximum time 710b is shorter than the first maximum time 710a, only the first test case 105a and the second test case 105b are selected. In one embodiment, the second test case 105b and the third test case 105c have a same priority. The second test case 105b may be selected as having the worst past failures history 210.

FIG. 7C illustrates a third maximum time 710c. The third test case 105c may be selected instead of the second test case 105b because the third test case 105c has a shortest minimum expected time duration.

The embodiments automatically generate a test suite 100 for a maximum time. The generated test suite 100 selects high priority test cases 105 over low priority test cases 105 and selects greater intensities 330 for higher priority test cases 105, while the execution time does not exceed the maximum time. The embodiments further support modifying the test suite 100 during execution to accommodate a lengthened or shortened maximum time.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating a test suite comprising:
receiving a maximum time for executing a plurality of test cases, each test case comprising metadata specifying a priority, an expected time duration for each of a plurality of intensities, a past failures history, and required test resources, each test case further comprising a plurality of components, each component comprising test instructions and an intensity;
selecting a first test case of the plurality of test cases with a specified priority selected iteratively from a highest priority to a lowest priority as a selected test case if combined expected time durations for all selected test cases and a minimum expected time duration of the first test case is less than the maximum time;
selecting a specified intensity for the first test case such that the combined expected time durations for all selected test cases is less than the maximum time; and
generating the test suite from the selected test cases and the specified intensity for each selected test case.

2. The method of claim 1, wherein the test suite is generated with the selected test cases arranged in a descending priority order.

3. The method of claim 1, wherein the first test case is selected from other test cases with the specified priority in response to the first test case having a worst past failures history.

4. The method of claim 1, wherein the first test case is selected from other test cases with the specified priority in response to the first test case having a shortest minimum expected time duration.

5. The method of claim 1, wherein a higher intensity is selected for the first test case relative to other test cases with the specified priority in response to the first test case having a worst past failures history.

6. The method of claim 1, wherein a higher intensity is selected for the first test case relative to other test cases with the specified priority in response to the first test case having a shortest minimum expected time duration for the higher intensity.

7. The method of claim 1, further comprising:
receiving an increase of the maximum time;
iteratively selecting the specified priority from the highest priority to the lowest priority; and
modifying the specified intensity for each selected test case with the specified priority such that the combined expected time durations for all selected test cases is less than the maximum time.

8. The method of claim 7, further comprising selecting a second test case of the plurality of test cases as a selected test case if the combined expected time durations for all selected test cases and the minimum expected time duration of the second test case is less than the maximum time.

9. The method of claim 7, wherein only the priorities of unexecuted test cases are selected.

10. The method of claim 1, further comprising
receiving a decrease of the maximum time;
iteratively selecting the specified priority from the lowest priority to the highest priority; and
modifying the specified intensity for each selected test case with the specified priority such that the combined expected time durations for all selected test cases is less than the maximum time.

11. The method of claim 10, the method further comprising deselecting a second test case with the specified priority if the combined expected time durations for all the selected test cases is not less than the maximum time.

12. An apparatus comprising:
a computer readable storage medium storing computer readable program code executable by a processor, the computer readable program code comprising:
a selection module receiving a maximum time for executing a plurality of test cases, each test case comprising metadata specifying a priority, an expected time duration for each of a plurality of intensities, a past failures history, and required test resources, each test case further comprising a plurality of components, each component comprising test instructions and an intensity, the selection module further selecting a first test case of the plurality of test cases with a specified priority selected iteratively from a highest priority to a lowest priority as a selected test case if combined expected time durations for all selected test cases and a minimum expected time duration of the first test case is less than the maximum time; and
a generation module selecting a specified intensity for the first test case such that the combined expected time durations for all selected test cases is less than the maximum time and generating the test suite from the selected test cases and the specified intensity for each selected test case.

13. The apparatus of claim 12, wherein the first test case is selected from other test cases with the specified priority in response to the first test case having a worst past failures history.

14. The apparatus of claim 12, wherein the first test case is selected from other test cases with the specified priority in response to the first test case having a shortest minimum expected time duration.

15. A computer program product for generating a test suite, the computer program product comprising:
a computer readable storage medium having computer readable program code embodied therein, the computer readable program code configured to:
receive a maximum time for executing a plurality of test cases, each test case comprising metadata specifying a priority, an expected time duration for each of a plurality of intensities, a past failures history, and required test resources, each test case further comprising a plurality of components, each component comprising test instructions and an intensity;
select a first test case of the plurality of test cases with a specified priority selected iteratively from a highest priority to a lowest priority as a selected test case if combined expected time durations for all selected test cases and a minimum expected time duration of the first test case is less than the maximum time;
select a specified intensity for the first test case such that the combined expected time durations for all selected test cases is less than the maximum time; and
generate the test suite from the selected test cases and the specified intensity for each selected test case.

16. The computer program product of claim 15, wherein a higher intensity is selected for the first test case relative to other test cases with the specified priority in response to the first test case having a worst past failures history.

17. The computer program product of claim 15, wherein a higher intensity is selected for the first test case relative to other test cases with the specified priority in response to the first test case having a shortest minimum expected time duration for the higher intensity.

18. The computer program product of claim 15, the computer readable program code further:
receiving an increase of the maximum time;
iteratively selecting the specified priority from the highest priority to the lowest priority; and
modifying the specified intensity for each selected test case with the specified priority such that the combined expected time durations for all selected test cases is less than the maximum time.

19. The computer program product of claim 18, the computer readable program code further selecting a second test case of the plurality of test cases as a selected test case if the combined expected time durations for all selected test cases and the minimum expected time duration of the second test case is less than the maximum time.

20. The computer program product of claim 18, wherein only the priorities of unexecuted test cases are selected.
